(19) United States
(12) Patent Application Publication
(10) Pub. No.: US 2018/0251406 A1
(43) Pub. Date: Sep. 6, 2018

(54) SINTERED CERAMIC PROTECTIVE LAYER FORMED BY HOT PRESSING

(71) Applicant: Applied Materials, Inc., Santa Clara, CA (US)

(72) Inventors: Jennifer Y. Sun, Mountain View, CA (US); Guodong Zhan, Dhahran (SA); David Fenwick, Los Altos Hills, CA (US); Michael R. Rice, Pleasanton, CA (US)

(21) Appl. No.: 15/907,154

(22) Filed: Feb. 27, 2018

Related U.S. Application Data
(60) Provisional application No. 62/467,724, filed on Mar. 6, 2017.

(51) Int. Cl. C04B 35/622; C04B 41/00; C04B 41/50; C04B 35/645

(52) U.S. Cl. CPC C04B 35/62222; C04B 41/009; C04B 41/5045; C04B 41/5055; C04B 2235/6025; C04B 41/5032; C04B 35/645; C04B 2235/612; C04B 41/5042

(57) ABSTRACT

Disclosed herein are methods for fabricating layered ceramic materials via hot pressing. A method includes disposing a powder compact or a ceramic slurry onto a surface of an article, wherein the article is a chamber component of a processing chamber. The powder compact or ceramic slurry is hot pressed against the surface of the article by heating the article and the powder compact or ceramic slurry and applying a pressure of 15-100 Megapascals. The hot pressing sinters the powder compact or ceramic slurry into a sintered ceramic protective layer and bonds the sintered ceramic protective layer to the surface of the article.

### RELATED APPLICATIONS

This patent application claims the benefit under 35 U.S.C. § 119(e) of U.S. Provisional Application No. 62/467,724, filed Mar. 6, 2017, which is herein incorporated by reference.

### TECHNICAL FIELD

Embodiments of the present invention relate, in general, to a method of forming a sintered ceramic protective layer on a semiconductor processing chamber component through hot pressing.

### BACKGROUND

In the semiconductor industry, devices are fabricated by a number of manufacturing processes producing structures of ever-decreasing size. Some manufacturing processes such as plasma etch and plasma clean processes expose a substrate support (e.g., an edge of the substrate support during wafer processing and the full substrate support during chamber cleaning) to a high-speed stream of plasma to etch or clean the substrate. The plasma may be highly corrosive, and may corrode processing chambers and other surfaces that are exposed to the plasma.

Sintering technology has been used to produce monolithic bulk ceramics, such as manufacturing chamber components. However, some monolithic bulk ceramics that have desirable plasma resistance properties are expensive to manufacture and have undesirable structural properties. Additionally, some monolithic bulk ceramics that have desirable structural properties and that are relatively inexpensive to manufacture have undesirable plasma resistance properties.

### SUMMARY

Embodiments of the present disclosure relate to the production of sintered ceramic protective layers and layered bulk ceramics via hot pressing technology. In one embodiment, a method includes disposing a powder compact onto a surface of an article, wherein the article is a chamber component of a processing chamber. The powder compact is hot pressed against the surface of the article by heating the article and the powder compact and applying a pressure of 15-100 Megapascals. The hot pressing sinters the powder compact into a sintered ceramic protective layer and bonds the sintered ceramic protective layer to the surface of the article.

In another embodiment, a method includes disposing a ceramic slurry onto a surface of an article, wherein the article is a chamber component of a processing chamber. The ceramic slurry or a green body formed from the ceramic slurry is hot pressed against the surface of the article by heating the article and the ceramic slurry or green body and applying a pressure of 15-100 Megapascals. The hot pressing sinters the ceramic slurry or green body into a sintered ceramic protective layer and bonds the sintered ceramic protective layer to the surface of the article.

In another embodiment, a method includes disposing a second sintered ceramic article onto a first sintered ceramic article, wherein the first sintered ceramic article is a chamber component of a processing chamber. The second sintered ceramic article is hot pressed against the first sintered ceramic article by heating the first and second sintered ceramic articles and applying a pressure of 15-100 Megapascals. The hot pressing bonds the second sintered ceramic article to the first sintered ceramic article.

### BRIEF DESCRIPTION OF THE DRAWINGS

Embodiments of the present invention are illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts a sectional view of a processing chamber according to an embodiment;

FIG. 2 depicts an exemplary architecture of a manufacturing system according to an embodiment;

FIG. 3A depicts a sectional view of a hot pressing chamber according to an embodiment;

FIG. 3B depicts a sectional view of a hot pressing chamber that uses a mold, according to an embodiment;

FIGS. 4A-4D depict sectional side views of exemplary articles with one or more ceramic green bodies, ceramic slurries, powder compacts and/or sintered ceramic protective layers disposed thereon according to embodiments;

FIG. 5 is a flow diagram illustrating a process for forming a sintered ceramic protective layer onto an article from a powder compact, according to an embodiment;

FIG. 6 is a flow diagram illustrating a process for forming multi-layer sintered ceramic by hot pressing two pre-sintered ceramic articles together, according to an embodiment; and

FIG. 7 is a flow diagram illustrating a process for forming a sintered ceramic protective layer onto an article from a ceramic slurry, according to an embodiment;

### DETAILED DESCRIPTION OF EMBODIMENTS

Embodiments of the present invention provide an article, such as a chamber component for a processing chamber. One or more ceramic layers may be formed on the article by disposing a powder compact or ceramic slurry on the article and sintering the powder compact or ceramic slurry using a hot pressing technique to form a dense sintered ceramic protective layer joined to the article. In some embodiments, multiple sintered ceramic protective layers are formed by repeating the process of applying a powder compact or ceramic slurry to the article and hot pressing. Each resulting sintered ceramic protective layer may have a composition of one or more of Y₃Al₅O₁₂ (YAG), Y₄Al₂O₉(YAM), Y₂O₃, Er₂O₃, Gd₂O₃, Gd₃Al₅O₁₂ (GAG), YF₃, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, or a ceramic compound composed of Y₄Al₂O₉ and at least one phase consisting of Y₂O₃—ZrO₂ (e.g., a solid solution of Y₂O₃—ZrO₂). The improved plasma erosion resistance provided by one or more of the disclosed sintered ceramic protective layers may improve the service life of the chamber component, while reducing maintenance and manufacturing cost.

Traditional ceramic coating techniques suffer from a unique set of disadvantages or difficulties. For example, ceramic layers formed by plasma spray and other thermal spray techniques are generally porous (e.g., with a porosity of about 3-5%), and the porosity reduces an effectiveness of preventing erosion by plasma chemistry. Ceramic layers formed from techniques such as ion assisted deposition (IAD), physical vapor deposition (PVD) and sputtering are relatively thin and often include vertical cracks and boundary defects at locations of substrate imperfections. The vertical cracks and boundary defects reduce an effectiveness of the ceramic layer at mitigating erosion by plasma chemistry. Atomic layer deposition (ALD) is very time consuming and costly, and produces very thin films.

Embodiments discussed herein detail how to form a sintered ceramic protective layer and a multi-layer ceramic article via hot pressing. The multi-layer ceramic article may include a pre-sintered ceramic article that is relatively inexpensive and that has desirable structural properties and/or thermal conductivity properties. An example of such a pre-sintered ceramic article is a pre-sintered Al₂O₃ chamber component for a processing chamber. Hot pressing may be performed to form a sintered ceramic protective layer over the pre-sintered ceramic article. The sintered ceramic protective layer has superior erosion and corrosion resistance properties (e.g., improved erosion and plasma resistance to plasma environments), but may be composed of a more expensive material than the pre-sintered ceramic article and/or may have less desirable structural properties and/or thermal conductivity properties (e.g., a lower elastic modulus, a lower wear resistance, lower mechanical strength, a lower thermal conductivity, and so on). The sintered ceramic protective layer may have a thickness of about 1-100 microns (e.g., that is thicker than what is generally achievable by IAD, PVD and ALD processes), a relatively low porosity of about 1% or less (e.g., that is lower than the porosity that is generally achievable by plasma spray processes), and may lack vertical cracks and boundary defects. In some embodiments, the porosity may be around 0.1%. The porosity is a measure of the void spaces in the sintered ceramic protective layer, and is a fraction of the volume of voids over the total volume. The large thickness of the sintered ceramic protective layer may act as a diffusion barrier that prevents contaminants from diffusing from the article and onto a processed substrate.

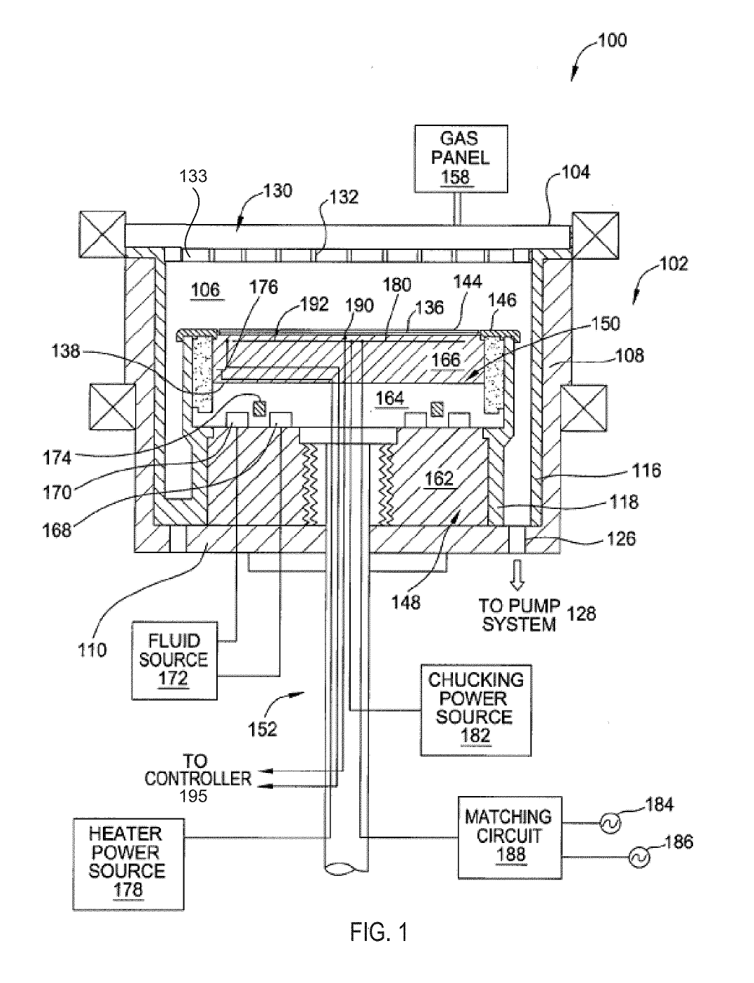

FIG. 1 is a sectional view of a semiconductor processing chamber 100 having one or more chamber components that are coated with a sintered ceramic protective layer in accordance with embodiments of the present invention. The processing chamber 100 may be used for processes in which a corrosive plasma environment is provided. For example, the processing chamber 100 may be a chamber for a plasma etcher or plasma etch reactor, a plasma cleaner, and so forth. Examples of chamber components that may include a ceramic layer include a substrate support assembly 148, an electrostatic chuck (ESC) 150, a ring (e.g., a process kit ring or single ring), a chamber wall, a base, a gas distribution plate, a showerhead, a liner, a liner kit, a shield, a plasma screen, a flow equalizer, a cooling base, a chamber viewport, a chamber lid 104, a nozzle, and so on. The sintered ceramic protective layer, which is described in greater detail below, may be formed by hot pressing, and may be formed of a ceramic material that includes one or more of Y₃Al₅O₁₂, Y₄Al₂O₉, Y₂O₃, Er₂O₃, Gd₂O₃, Gd₃Al₅O₁₂, YF₃, Nd₂O₃, Er₄Al₂O₉, Er₃Al₅O₁₂, ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, a ceramic compound composed of Y₄Al₂O₉ and at least one phase of Y₂O₃—ZrO₂, or a solid solution or multiphase compound of Y₂O₃—ZrO₂—Al₂O₃. As illustrated, the substrate support assembly 148 has a sintered ceramic protective layer 136, in accordance with one embodiment. However, it should be understood that any of the other chamber components, such as those listed above, may also include a sintered ceramic protective layer.

In one embodiment, the processing chamber 100 includes a chamber body 102 and a showerhead 130 that enclose an interior volume 106. Alternatively, the showerhead 130 may be replaced by a lid and a nozzle in some embodiments. The chamber body 102 may be fabricated from aluminum, stainless steel or other suitable material. The chamber body 102 generally includes sidewalls 108 and a bottom 110. One or more of the showerhead 130 (or lid and/or nozzle), sidewalls 108 and/or bottom 110 may include a ceramic layer.

An outer liner 116 may be disposed adjacent the sidewalls 108 to protect the chamber body 102. The outer liner 116 may be fabricated and/or coated with a ceramic layer. In one embodiment, the outer liner 116 is fabricated from aluminum oxide (Al₂O₃).

An exhaust port 126 may be defined in the chamber body 102, and may couple the interior volume 106 to a pump system 128. The pump system 128 may include one or more pumps and throttle valves utilized to evacuate and regulate the pressure of the interior volume 106 of the processing chamber 100.

The showerhead 130 may be supported on the sidewall 108 of the chamber body 102. The showerhead 130 (or lid) may be opened to allow access to the interior volume 106 of the processing chamber 100, and may provide a seal for the processing chamber 100 while closed. A gas panel 158 may be coupled to the processing chamber 100 to provide process and/or cleaning gases to the interior volume 106 through the showerhead 130 or lid and nozzle. Showerhead 130 may be used for processing chambers used for dielectric etch (etching of dielectric materials). The showerhead 130 includes a gas distribution plate (GDP) 133 having multiple gas delivery holes 132 throughout the GDP 133. The showerhead 130 may include the GDP 133 bonded to an aluminum base or an anodized aluminum base. The GDP 133 may be made from Si or SiC, or may be a ceramic such as Y₂O₃, Al₂O₃, YAG, and so forth.

For processing chambers used for conductor etch (etching of conductive materials), a lid may be used rather than a showerhead. The lid may include a center nozzle that fits into a center hole of the lid. The lid may be a ceramic such as Al₂O₃ or Y₂O₃. The nozzle may also be a ceramic, such as Al₂O₃ or Y₂O₃. The lid, base of showerhead 130, GDP 133 and/or nozzle may be coated with a sintered ceramic protective layer as described herein.

Examples of processing gases that may be used to process substrates in the processing chamber 100 include halogen-containing gases, such as C₂F₆, SF₆, SiCl₄, HBr, NF₃, CF₄, CHF₃, CH₂F₃, F, NF₃, Cl₂, CCl₄, BCl₃ and SiF₄, among others, and other gases such as O₂, or N₂O. Examples of carrier gases include N₂, He, Ar, and other gases inert to process gases (e.g., non-reactive gases). The sintered ceramic protective layer may be plasma resistant, and may be resistant to plasmas and chemistries based on some or all of the aforementioned halogen-containing gases. The substrate support assembly 148 is disposed in the interior volume 106 of the processing chamber 100 below the showerhead 130 or lid. The substrate support assembly 148 holds the substrate 144 during processing. A ring 146 (e.g., a single ring) may cover a portion of the electrostatic chuck 150, and may protect the covered portion from exposure to plasma during processing. The ring 146 may be silicon or quartz in one embodiment.

An inner liner 118 may be coated on the periphery of the substrate support assembly 148. In one embodiment, the inner liner 118 may be fabricated from the same materials of the outer liner 116. Additionally, the inner liner 118 may be coated with a sintered ceramic protective layer.

In one embodiment, the substrate support assembly 148 includes a mounting plate 162 supporting a pedestal 152, and an electrostatic chuck 150. The electrostatic chuck 150 further includes a thermally conductive base 164 and an electrostatic puck 166 bonded to the thermally conductive base by a bond 138, which may be a silicone bond in one embodiment. An upper surface of the electrostatic puck 166 is covered by the sintered ceramic protective layer 136 in the illustrated embodiment. In one embodiment, the sintered ceramic protective layer 136 is disposed on the upper surface of the electrostatic puck 166. In another embodiment, the sintered ceramic protective layer 136 is disposed on the entire exposed surface of the electrostatic chuck 150 including the outer and side periphery of the thermally conductive base 164 and the electrostatic puck 166. The mounting plate 162 is coupled to the bottom 110 of the chamber body 102 and includes passages for routing utilities (e.g., fluids, power lines, sensor leads, etc.) to the thermally conductive base 164 and the electrostatic puck 166.

The thermally conductive base 164 and/or electrostatic puck 166 may include one or more optional embedded heating elements 176, embedded thermal isolators 174 and/or conduits 168, 170 to control a lateral temperature profile of the substrate support assembly 148. The conduits 168, 170 may be fluidly coupled to a fluid source 172 that circulates a temperature regulating fluid through the conduits 168, 170. The embedded thermal isolator 174 may be disposed between the conduits 168, 170 in one embodiment. The heater 176 is regulated by a heater power source 178. The conduits 168, 170 and heater 176 may be utilized to control the temperature of the thermally conductive base 164, which may be used for heating and/or cooling the electrostatic puck 166 and a substrate 144 (e.g., a wafer) being processed. The temperature of the electrostatic puck 166 and the thermally conductive base 164 may be monitored using a plurality of temperature sensors 190, 192, which may be monitored using a controller 195.

The electrostatic puck 166 may further include multiple gas passages such as grooves, mesas and other surface features, which may be formed in an upper surface of the electrostatic puck 166 and/or the sintered ceramic protective layer 136. The gas passages may be fluidly coupled to a source of a heat transfer (or backside) gas such as helium via holes drilled in the electrostatic puck 166. In operation, the backside gas may be provided at controlled pressure into the gas passages to enhance the heat transfer between the electrostatic puck 166 and the substrate 144. The electrostatic puck 166 includes at least one clamping electrode 180 controlled by a chucking power source 182. The clamping electrode 180 (or other electrode disposed in the electrostatic puck 166 or conductive base 164) may further be coupled to one or more RF power sources 184, 186 through a matching circuit 188 for maintaining a plasma formed from process and/or other gases within the processing chamber 100. The power sources 184, 186 are generally capable of producing an RF signal having a frequency from about 50 kHz to about 3 GHz, with a power output of up to about 10,000 Watts.

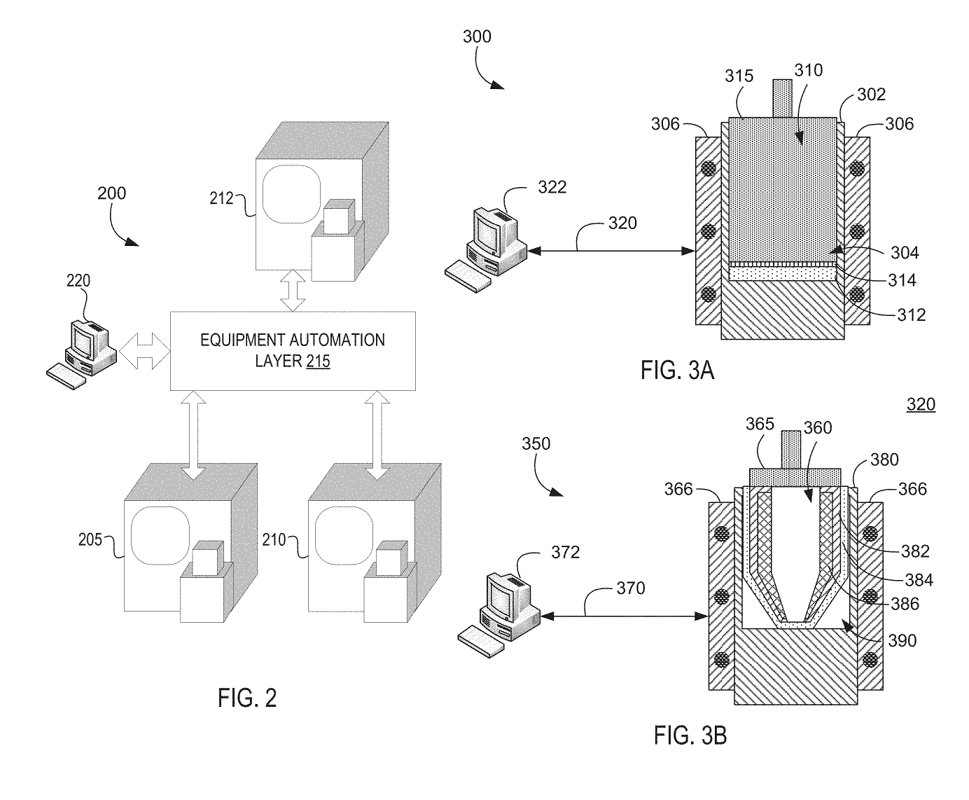

FIG. 2 illustrates an exemplary architecture of a manufacturing system, in accordance with one embodiment of the present invention. The manufacturing system 200 may be a ceramics manufacturing system, which may include the processing chamber 100. In some embodiments, the manufacturing system 200 may be a processing chamber for manufacturing, cleaning, or modifying a chamber component of the processing chamber 100. In one embodiment, manufacturing system 200 includes a first furnace 205 (e.g., used for hot pressing), a second furnace 120 (e.g., used for burning off organic binders), a laser cutter 212, an equipment automation layer 215, and/or a computing device 220. In alternative embodiments, the manufacturing system 200 may include more or fewer components. For example, manufacturing system may not include the laser cutter 212 in some embodiments and/or may not include the second furnace 210 in some embodiments. In further embodiments, the manufacturing system 200 may consist of the first furnace 205, which may be a manual off-line machine.

The first furnace 205 may be a machine designed to perform hot pressing. The first furnace 205 may heat articles such as ceramic articles and concurrently apply pressure that compresses a powder compact, ceramic slurry, green body and/or pre-sintered article against a chamber component of a processing chamber. The first furnace 205 may include a thermally insulated chamber, or oven, capable of applying a controlled temperature on articles inserted therein. The first furnace 205 may include a press that is capable of exerting a high pressure to press a material (e.g., a ceramic slurry, powder compact, green body, pre-sintered article, etc.) against an article. In one embodiment, the press applies uniaxial pressure.

In one embodiment, a chamber of the first furnace is hermitically sealed. The first furnace 205 may include a pump to pump air out of the chamber, and thus to create a vacuum within. The first furnace 205 may additionally or alternatively include a gas inlet to pump gasses (e.g., inert gasses such as Ar or N₂) into its interior.

The first furnace 205 may include a manual furnace having a temperature controller that is manually set by a technician during processing of ceramic articles. The first furnace 205 may also be an off-line machine that can be programmed with a process recipe. The process recipe may control ramp up rates, ramp down rates, process times, temperatures, pressure, gas flows, applied voltage potentials, electrical currents, and so on. Alternatively, first furnace 205 may be an on-line automated machine that can receive process recipes from computing devices 220 (e.g., personal computers, server machines, etc.) via an equipment automation layer 215. The equipment automation layer 215 may interconnect the first furnace 205 with computing devices 220, with other manufacturing machines, with metrology tools, and/or other devices.

The second furnace 210 may be a similar to first furnace 205, and may include a thermally insulated chamber, or oven, capable of applying a controlled temperature on articles inserted therein. In one embodiment, a chamber of the second furnace is hermitically sealed. The second furnace 210 may include a pump to pump air out of the chamber, and thus to create a vacuum within. The second furnace 210 may additionally or alternatively include a gas inlet to pump gasses (e.g., inert gasses such as Ar or N₂) into its interior. Notably, the second furnace 210 may not include a press. In embodiments, the second furnace 210 is used to burn off organic materials (e.g., organic binders from a ceramic slurry). The first furnace 205 may not be used to burn off the organics because the organics might contaminate the first furnace 205. Accordingly, second furnace 210 may be a dedicated machine used for burning off organics. An article with a ceramic slurry on at least one surface may first be processed in the second furnace 210 to burn off an organic binder and then may be processed in the first furnace 205 to form a sintered ceramic protective layer bonded to the article.

Laser cutter 212 is a computer numerical control (CNC) machine that directs a focused laser beam to cut a target. The laser cutter 212 may be, for example, a neodymium laser, a neodymium yttrium-aluminum-garnet (Nd-YAG) laser or other type of laser. The focused laser beam may cut the sintered ceramic protective layer after the sintered ceramic protective layer is formed in the first furnace 205. The sintered ceramic protective layer may be cut to achieve a target shape. For example, the sintered ceramic protective layer may be cut to the shape of a nozzle or other three-dimensional shape. Alternatively, the sintered ceramic protective layer may have a target shape without performing laser cutting. For example, complex and/or three-dimensional shapes may be achieved by using a mold during the hot pressing in first furnace 205.

The equipment automation layer 215 may include a network (e.g., a location area network (LAN)), routers, gateways, servers, data stores, and so on). The first furnace 205, second furnace 210 and/or laser cutter 212 may connect to the equipment automation layer 215 via a SEMI Equipment Communications Standard/Generic Equipment Model (SECS/GEM) interface, via an Ethernet interface, and/or via other interfaces. In one embodiment, the equipment automation layer 215 enables process data (e.g., data collected by the first furnace 205, second furnace 210 and/or laser cutter 212 during a process run) to be stored in a data store (not shown). In an alternative embodiment, the computing device 220 connects directly to the first furnace 205, second furnace 210 and/or laser cutter 212.

In one embodiment, the first furnace 205, second furnace 210 and/or laser cutter 212 includes a programmable controller that can load, store and execute process recipes. A programmable controller may control temperature settings, gas and/or vacuum settings, time settings, applied voltage potentials, electrical currents, pressure settings, etc. of first furnace 205. Similarly, a programmable controller may control temperature settings, gas and/or vacuum settings, time settings, applied voltage potentials, electrical currents, etc. of second furnace 210. Similarly, a programmable controller may control power settings, may control a position and orientation of a laser beam, and so on. The programmable controller of either furnace may control a chamber heat up, may enable temperature to be ramped down as well as ramped up, may enable multi-step heat treating to be input as a single process, may control pressure applied by a press, and so forth. A programmable controller of laser cutter 212 may receive an electronic file that includes a sequence of cuts to make to achieve a target shape for the sintered ceramic protective layer. The programmable controllers may include a main memory (e.g., read-only memory (ROM), flash memory, dynamic random access memory (DRAM), static random access memory (SRAM), etc.), and/or a secondary memory (e.g., a data storage device such as a disk drive). The main memory and/or secondary memory may store instructions for performing hot pressing, heating and/or laser cutting processes, as described herein.

The programmable controllers may also include a processing device coupled to the main memory and/or secondary memory (e.g., via a bus) to execute the instructions. The processing device may be a general-purpose processing device such as a microprocessor, central processing unit, or the like. The processing device may also be a special-purpose processing device, such as an application specific integrated circuit (ASIC), a field programmable gate array (FPGA), a digital signal processor (DSP), a network processor, or the like. In one embodiment, programmable controller is a programmable logic controller (PLC).

FIG. 3A depicts sintering system 300 that includes a sectional view of a hot pressing chamber 302 according to an embodiment. For example, sintering system 300 may be the same or similar to manufacturing system 200 described with respect to FIG. 2. Sintering system 300 may be configured to perform hot pressing of a ceramic slurry, green body or powder compact against an article to form a sintered ceramic protective layer on the article. As used herein, a green body is a ceramic layer that has not yet been sintered, and includes a ceramic slurry, a powder compact, and a sol-gel that has been formed into a layer on an article.

Sintering system 300 includes hot pressing chamber 302 having an interior 304 surrounded by walls and a bottom. In some embodiments, the interior 304 may be a sealed chamber capable of maintaining low or high pressure conditions, and may be coupled to appropriate gas flow sources. In some embodiments, the hot pressing chamber 302 includes a furnace 306, which may enclose the hot pressing chamber 302, for example, in a cylindrical fashion. The furnace 306 may be programmable, and include one or more temperature sensors disposed within the hot pressing chamber 302 to provide feedback utilized to maintain a target temperature. The furnace 306 may also be capable of ramping to a target temperature at a target rate. In some embodiments, the furnace 306 may be operatively coupled to a computing device 322 (which may be the same or similar to computing device 220 described with respect to FIG. 2) using, for example, a communications path 320. The computing device 322 may run one or many stored recipes (which may be pre-defined or operator-defined) that control the conditions of the furnace 306.

The hot pressing chamber 302 may include an opening 310 at one end. An article 312 on which a green body 314 has been formed may be inserted into the hot pressing chamber 302. The green body 314 may be a ceramic slurry, powder compact, sol-gel or other ceramic compound. A press 315 may then apply pressure to compress the green body 314 against the article 312. The press 315 (also referred to as a punch) applies pressure while the furnace 306 heats the article 312 and green body 314. Note that only a single upper press 315 is shown. However, in embodiments a lower press may also be used that presses in an opposite direction from the upper press 315. The heat and pressure cause the green body 314 to become a sintered ceramic protective layer that is bonded to the article 312.

FIG. 3B depicts sintering system 350 that includes a sectional view of a hot pressing chamber 380 according to an embodiment. For example, sintering system 350 may be the same or similar to manufacturing system 200 described with respect to FIG. 2. Sintering system 350 may be configured to perform hot pressing of a green body such as a ceramic slurry or powder compact against an article to form a sintered ceramic protective layer on the article.

Sintering system 350 includes hot pressing chamber 380 having an interior 390 surrounded by walls and a bottom. In some embodiments, the interior 390 may be a sealed chamber capable of maintaining low or high pressure conditions, and may be coupled to appropriate gas flow sources. In some embodiments, the hot pressing chamber 380 includes a furnace 366, which may enclose the hot pressing chamber 380, for example, in a cylindrical fashion. The furnace 366 may be programmable, and include one or more temperature sensors disposed within the hot pressing chamber 380 to provide feedback utilized to maintain a target temperature. The furnace 366 may also be capable of ramping to a target temperature at a target rate. In some embodiments, the furnace 366 may be operatively coupled to a computing device 372 (which may be the same or similar to computing device 220 described with respect to FIG. 2) using, for example, a communications path 370. The computing device 372 may run one or many stored recipes (which may be pre-defined or operator-defined) that control the conditions of the furnace 366.

The hot pressing chamber 380 may include an opening 360 at one end. An article 386 on which a green body 382 has been formed may be inserted into a mold 384. The green body 382 may be formed on the article 386 before or after the article 286 is inserted into the mold 384. An assembly of the article 386, green body 382 and mold 384 may be inserted into the hot pressing chamber 380. The green body 382 may be a ceramic slurry, powder compact, sol-gel or other ceramic compound. A press 365 may then apply pressure to compress the green body 382 against the article 386. The press 365 applies pressure while the furnace 366 heats the article 386 and green body 382. The heat and pressure cause the green body 382 to become a sintered ceramic protective layer that is bonded to the article 386. The mold 384 may shape the green body 382 so that the green body 382 achieves a shape that conforms to an inner shape of the mold 384. Accordingly, complex and/or three-dimensional shapes may be achieved for the sintered ceramic protective layer.

In some embodiments, the green body 314 and/or green body 382 are in the form of a powder compact. In some embodiments, the green body 314 and/or green body 382 are in the form of a sol-gel. In some embodiments, the green body 314 and/or 382 may be in the form of a ceramic slurry. For example, the ceramic slurry may a slurry of ceramic particles within a solvent. The solvent may include a low molecular weight polar solvent, including, but not limited to, ethanol, methanol, acetonitrile, water, or combinations thereof. In some embodiments, a pH of the ceramic slurry may be between about 5 and 12 to promote stability of the ceramic slurry. The ceramic slurry may have high viscosity to allow the slurry to be shaped into a target shape prior to sintering.

In some embodiments, a mass-median-diameter (D50) of the particles in the ceramic slurry, which is the average particle diameter by mass, may be between about 10 nanometers and 10 micrometers. In some embodiments, a D50 of the particles may be greater than 10 micrometers. In some embodiments, the slurry may be referred to as a nanoparticle slurry when the D50 of the particles is less than 1 micrometer. In some embodiments, the particles in the green body 314 and/or green body 382 may have compositions that include one or more of Er₂O₃, Gd₂O₃, Gd₃Al₅O₁₂, YF₃, Nd₂O₃, Er₄Al₂O₉, Er₃Al₅O₁₂, ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, or a ceramic compound composed of Y₄Al₂O₉ and at least one phase of Y₂O₃—ZrO₂.

In some embodiments, a single green body 314, 382 may be pressed or deposited (e.g., by dip-coating, a doctor blade technique, extrusion, etc.) onto article 312, 386, which may be a ceramic or metal base. In some embodiments, multiple sintered ceramic protective layers are formed in sequence. A new green body may be formed over a sintered ceramic protective layer and then processed by sintering system 300, 350 to form another sintered ceramic protective layer over the previously formed sintered ceramic protective layer. In some embodiments, a ceramic green body may be placed between two articles, such that the two articles will be joined together after the ceramic green body has sintered.

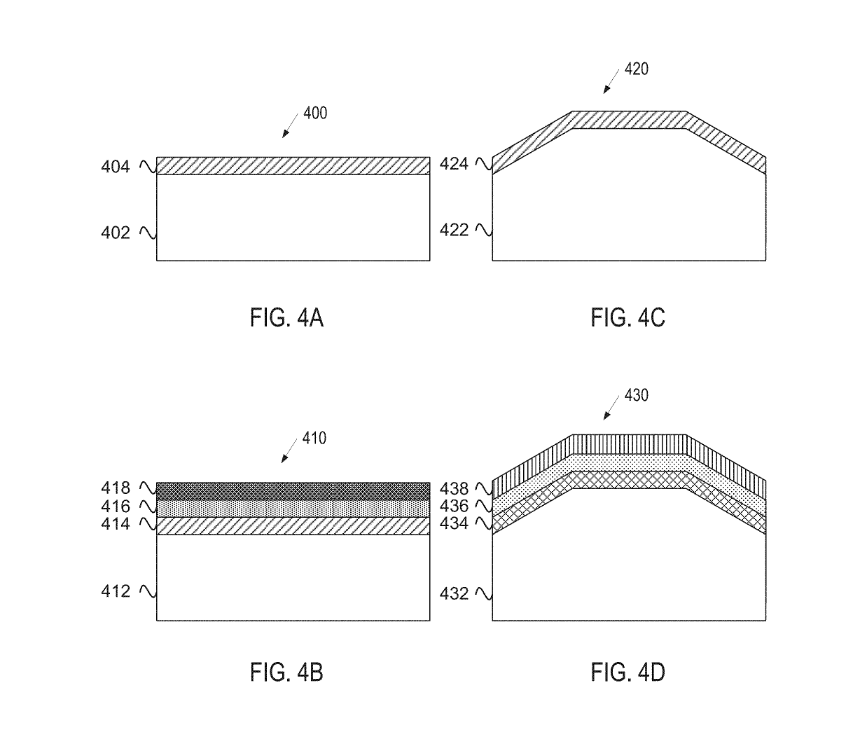

FIGS. 4A-4D depict sectional views of example articles with one or more ceramic green bodies and/or sintered ceramic protective layers disposed thereon according to embodiments. FIG. 4A shows single-layer-coated article 400. The article 400 may be a flat or planar article 402, which may be, for example, a ceramic article composed of one or more of Al₂O₃, AlN, Si₃N₄, or SiC. The article 402 includes a ceramic green body 404 disposed thereon (e.g., a powder compact, a ceramic slurry or a sol-gel). In some embodiments, the ceramic green body 404 may be a slurry that was deposited (e.g., by dip-coating, a doctor blade technique, extrusion, etc.) onto the surface of the article 402. In some embodiments, a thickness of the ceramic green body 404 may range from 1 micrometer to 100 micrometers. In some embodiments, the thickness of the ceramic green body 404 may be greater than 100 micrometers.

The article 400 may be loaded into the hot pressing chamber 302 or 380 of sintering system 300 or 350 to perform hot pressing, yielding a dense ceramic layer that is joined to the article 402.

Referring to FIG. 4B, a multi-layer-coated article 410 is depicted as article 412 having a first sintered ceramic protective layer 414, a second sintered ceramic protective layer 416, and a third sintered ceramic protective layer 418 disposed thereon in a layered fashion (e.g., a stack). In a similar manner as described with respect to FIG. 4A, hot pressing may be performed on the article 412 to produce a multi-layer ceramic article. The first sintered ceramic protective layer 414 may have been formed in a first hot press process, the second sintered ceramic protective layer 416 may have been formed in a second hot press process, and the third sintered ceramic protective layer 418 may have been formed in a third hot press process. Alternatively, a stack of three green bodies may have been formed, and a single hot pressing processing may have been performed to co-sinter all three of the green bodies to form the first sintered ceramic protective layer 412 bonded to article 412, the second sintered ceramic protective body 416 bonded to first sintered ceramic protective layer 414 and the third sintered ceramic protective layer 418 bonded to the second sintered ceramic protective layer 418.

In some embodiments, the sintered ceramic protective layers 414, 416 and 418 may each be composed of the same ceramic material. In some embodiments, the sintered ceramic protective layers 414, 416 and 418 may each be composed of different ceramic materials, or may have alternating compositions (e.g., the first 414 and third 418 sintered ceramic protective layers may be the same and the second sintered ceramic protective layer 416 may be different). In some embodiments, more or less than three sintered ceramic protective layers may be formed on the article 412. In some embodiments, the thicknesses of each layer of the stack may vary, with thicknesses of any suitable range described herein (e.g., described with respect to the ceramic green body 404).

Referring to FIGS. 4C and 4D, hot pressing can be performed on chamber components to produce dense ceramic layers thereon. For example, FIG. 4C depicts a single-layer-coated chamber component 420, and FIG. 4D depicts a multi-layer-coated chamber component 430. Each of articles 422 and 432 may be any chamber component described with respect to FIG. 1, including a support assembly, an electrostatic chuck (ESC), a ring (e.g., a process kit ring or single ring), a chamber wall, a base, a gas distribution plate or showerhead, a liner, a liner kit, a shield, a plasma screen, a flow equalizer, a cooling base, a chamber viewport, a chamber lid, and so on. The articles 422 and 432 may be metals, ceramics, metal-ceramic composites, polymers, or polymer-ceramic composites.

Various chamber components are composed of different materials. For example, an electrostatic chuck may be composed of a ceramic such as Al₂O₃ (alumina), AlN (aluminum nitride), TiO (titanium oxide), TiN (titanium nitride) or SiC (silicon carbide) bonded to an anodized aluminum base. Al₂O₃, AN and anodized aluminum have poor plasma erosion resistance. When exposed to a plasma environment with a fluorine chemistry and/or reducing chemistry, an electrostatic puck of an electrostatic chuck may exhibit degraded wafer chucking, increased helium leakage rate, wafer front-side and back-side particle production and on-wafer metal contamination after about 50 radio frequency hours (RFHrs) of processing. A radio frequency hour is an hour of processing.

A lid for a plasma etcher used for conductor etch processes may be a sintered ceramic such as Al₂O₃ since Al₂O₃ has a high flexural strength and high thermal conductivity. However, Al₂O₃ exposed to fluorine chemistries forms AlFₓ particles as well as aluminum metal contamination on wafers. Some chamber lids have a thick film protective layer on a plasma facing side to minimize particle generation and metal contamination and to prolong the life of the lid. However, most thick film coating techniques have a long lead time. Additionally, for most thick film coating techniques special surface preparation is performed to prepare the article to be coated (e.g., the lid) to receive the coating. Such long lead times and coating preparation steps can increase cost and reduce productivity, as well as inhibit refurbishment. Additionally, most thick-film coatings have inherent cracks and pores that might degrade on-wafer defect performance.

A process kit ring and a single ring may be used to seal and/or protect other chamber components, and are typically manufactured from quartz or silicon. These rings may be disposed around a supported substrate (e.g., a wafer) to ensure a uniform plasma density (and thus uniform etching). However, quartz and silicon have very high erosion rates under various etch chemistries (e.g., plasma etch chemistries). Additionally, such rings may cause particle contamination when exposed to plasma chemistries.

A showerhead for an etcher used to perform dielectric etch processes is typically made of anodized aluminum bonded to a SiC faceplate. When such a showerhead is exposed to plasma chemistries including fluorine, AlFₓ may form due to plasma interaction with the anodized aluminum base. Additionally, a high erosion rate of the anodized aluminum base may lead to arcing and ultimately reduce a mean time between cleaning for the showerhead.

The examples provided above set forth just a few chamber components whose performance may be improved by use of a flash sintered or spark plasma sintered protective layer as set forth in embodiments herein.

Referring back to FIGS. 4C and 4D, the article 422 of the chamber component 420 and the article 432 of the chamber component 430 each may include one or more surface features and/or have a three-dimensional shape (e.g., other than a planar shape). Referring to FIG. 4C, a sintered ceramic protective layer 424 may be formed on a contoured surface of the article 422. The sintered ceramic protective layer 424 may conform to a shape of the article 422 by using a mold or laser cutting.

Referring to FIG. 4D, at least a portion of article 432 of the chamber component 430 is coated with first 434, second 436, and third 438 sintered ceramic protective layers, similar to the article 412 of FIG. 4B. The sintered ceramic protective layers 414, 416, and 418 in the stack may all have the same thickness, or they may have varying thicknesses. Hot pressing of the chamber component 430 may have been performed to produce a multi-layer ceramic layer joined to the surface of the chamber component 430. Shapes of the sintered ceramic protective layers may be achieved using molds or laser cutting.

Any of the ceramic green bodies or ceramic layers/bodies produced by hot pressing of ceramic green bodies may be based on a multicomponent compound formed by any of the aforementioned ceramics. With reference to the ceramic compound composed of Y₄Al₂O₉ and at least one phase of Y₂O₃—ZrO₂, in one embodiment, the ceramic compound includes 62.93 molar ratio (mol %) Y₂O₃, 23.23 mol % ZrO₂ and 13.94 mol % Al₂O₃. In another embodiment, the ceramic compound can include Y₂O₃ in a range of 50-75 mol %, ZrO₂ in a range of 10-30 mol % and Al₂O₃ in a range of 10-30 mol %. In another embodiment, the ceramic compound can include Y₂O₃ in a range of 40-100 mol %, ZrO₂ in a range of 0-60 mol % and Al₂O₃ in a range of 0-10 mol %. In another embodiment, the ceramic compound can include Y₂O₃ in a range of 40-60 mol %, ZrO₂ in a range of 30-50 mol % and Al₂O₃ in a range of 10-20 mol %. In another embodiment, the ceramic compound can include Y₂O₃ in a range of 40-50 mol %, ZrO₂ in a range of 20-40 mol % and Al₂O₃ in a range of 20-40 mol %. In another embodiment, the ceramic compound can include Y₂O₃ in a range of 70-90 mol %, ZrO₂ in a range of 0-20 mol % and Al₂O₃ in a range of 10-20 mol %. In another embodiment, the ceramic compound can include Y₂O₃ in a range of 60-80 mol %, ZrO₂ in a range of 0-10 mol % and Al₂O₃ in a range of 20-40 mol %. In another embodiment, the ceramic compound can include Y₂O₃ in a range of 40-60 mol %, ZrO₂ in a range of 0-20 mol % and Al₂O₃ in a range of 30-40 mol %. In another embodiment, the ceramic compound can include Y₂O₃ in a range of 30-60 mol %, ZrO₂ in a range of 0-20 mol % and Al₂O₃ in a range of 30-60 mol %. In another embodiment, the ceramic compound can include Y₂O₃ in a range of 20-40 mol %, ZrO₂ in a range of 20-80 mol % and Al₂O₃ in a range of 0-60 mol %. In other embodiments, other distributions may also be used for the ceramic compound.

In one embodiment, an alternative ceramic compound that includes a combination of Y₂O₃, ZrO₂, Er₂O₃, Gd₂O₃ and SiO₂ is used for the sintered ceramic protective layer. In one embodiment, the alternative ceramic compound can include Y₂O₃ in a range of 40-45 mol %, ZrO₂ in a range of 0-10 mol %, Er₂O₃ in a range of 35-40 mol %, Gd₂O₃ in a range of 5-10 mol % and SiO2 in a range of 5-15 mol %. In another embodiment, the alternative ceramic compound can include Y₂O₃ in a range of 30-60 mol %, ZrO₂ in a range of 0-20 mol %, Er₂O₃ in a range of 20-50 mol %, Gd₂O₃ in a range of 0-10 mol % and SiO2 in a range of 0-30 mol %. In a first example, the alternative ceramic compound includes 40 mol % Y₂O₃, 5 mol % ZrO₂, 35 mol % Er₂O₃, 5 mol % Gd₂O₃ and 15 mol % SiO₂. In a second example, the alternative ceramic compound includes 45 mol % Y₂O₃, 5 mol % ZrO₂, 35 mol % Er₂O₃, 10 mol % Gd₂O₃ and 5 mol % SiO₂. In a third example, the alternative ceramic compound includes 40 mol % Y₂O₃, 5 mol % ZrO₂, 40 mol % Er₂O₃, 7 mol % Gd₂O₃ and 8 mol % SiO₂.

In one embodiment, the sintered ceramic protective layer includes a solid solution or multiphase compound of yttrium oxide and zirconium oxide (Y₂O₃—ZrO₂). The Y₂O₃—ZrO₂ compound may include Y₂O₃ at 30-99 mol % and ZrO₂ 1-70 mol %. In one embodiment, this compound includes 70-75 mol % Y₂O₃ and 25-30 mol % ZrO₂. In one embodiment, this compound includes 60-80 mol % Y₂O₃ and 20-40 mol % ZrO₂. In one embodiment, this compound includes 60-70 mol % Y₂O₃ and 20-30 mol % ZrO₂. In one embodiment, this compound includes 50-80 mol % Y₂O₃ and 20-50 mol % ZrO₂. Other mixtures of Y₂O₃ and ZrO₂ are also considered.

In one embodiment, the sintered ceramic protective layer is a yttrium oxy-fluoride (Y—O—F ceramic) having the empirical formula of YₓO_{y}F_{z}. X has a value of 0.5-4 in an embodiment. Y has a value of 0.1 to 1.9 times a value of x, and z has a value of 0.1 to 3.9 times the value of x. One embodiment of the yttrium oxy-fluoride is YOF (note: subscripts are omitted when the value is 1). Another embodiment of the yttrium oxy-fluoride is yttrium oxy-fluoride with a low fluoride concentration. Such yttrium oxy-fluoride may have an empirical formula of, for example, YO_{1.4}F_{0.2}. In such a configuration, there are, on average, 1.4 oxygen atoms per yttrium atom, and 0.2 fluorine atoms per yttrium atom. Conversely, one embodiment of the yttrium oxy-fluoride is yttrium oxy-fluoride with a high fluoride concentration. Such a yttrium oxy-fluoride may have an empirical formula of, for example, YO_{0.1}F_{2.8}. In such a configuration, there are, on average, 0.1 oxygen atoms per yttrium atom, and 2.8 fluorine atoms per yttrium atom.

The proportion of metal to oxygen and fluorine in the yttrium oxy-fluoride can also be expressed in terms of atomic percent. For example, for a metal such as yttrium having a valance of +3, a minimum oxygen content of 10 atomic percent corresponds with a maximum fluorine concentration of 63 atomic percent. Conversely, for the same metal having a valance of +3, a minimum fluorine content of 10 atomic percent corresponds with a maximum oxygen concentration of 52 atomic percent. Accordingly, yttrium oxy-fluoride may have approximately 27-38 at. % of the yttrium, 10-52 atomic % (at. %) oxygen and approximately 10-63 at. % fluorine. In one embodiment, the yttrium oxy-fluoride has 32-34 at. % of the yttrium, 30-36 at. % oxygen, and 30-38 at. % fluorine.

In some embodiments, the sintered ceramic protective layer of the Y—O—F ceramic has a Vicker's hardness of about 0.68 GPa, an elastic modulus of about 183 GPa, a Poisson's ratio of about 0.29, a fracture toughness of about 1.3 MPa·√m, and a thermal conductivity of about 16.9 W/m·K.

Any of the aforementioned sintered ceramic protective layers may be pure or may include trace amounts of other materials such as ZrO₂, Al₂O₃, SiO₂, B₂O₃, Er₂O₃, Nd₂O₃, Nb₂O₅, CeO₂, Sm₂O₃, Yb₂O₃, or other oxides. In one embodiment, the same ceramic material is not used for two adjacent ceramic layers. However, in another embodiment adjacent layers may be composed of the same ceramic.

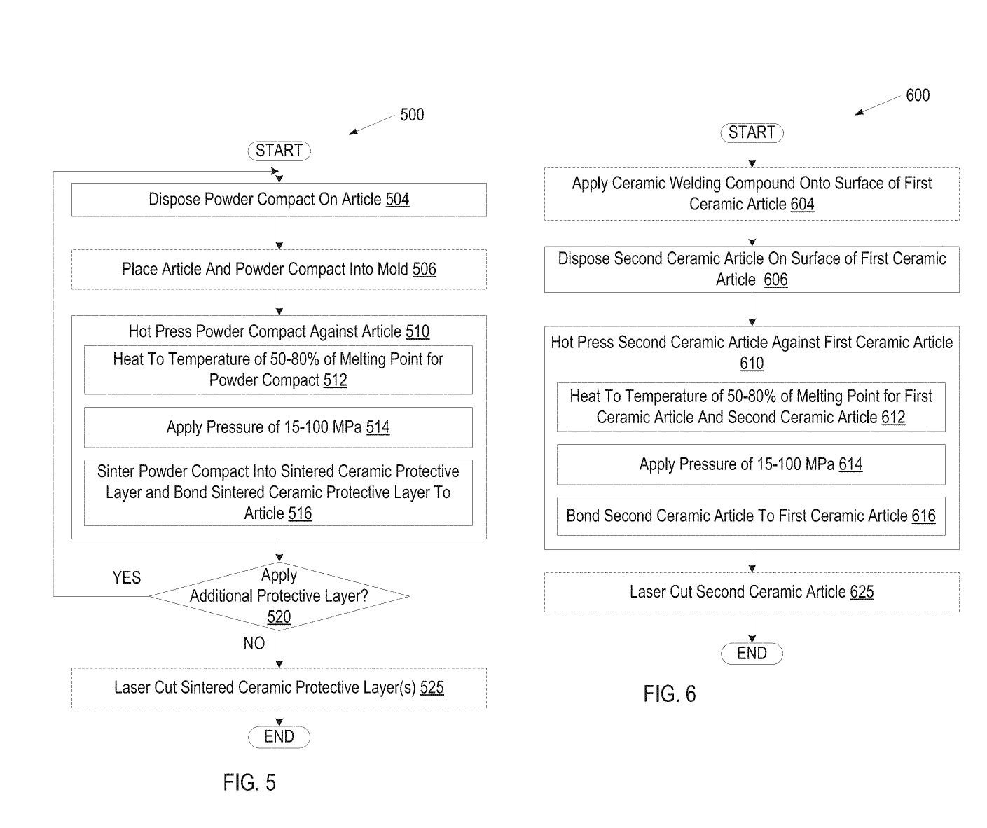

FIG. 5 is a flow diagram illustrating a method 500 for forming a sintered ceramic protective layer onto an article from a powder compact, according to an embodiment. At block 504 of method 500, an article is provided and a powder compact is disposed on a surface of the article. The powder compact may contain particles mixed via ball milling or other mixing methods. A dry milling agent of polyvinyl alcohol (PVA) may be applied at a concentration of 1 vol % during mulling. The dry milling agent can be removed through a heat treatment in vacuum at a temperature of about 300-400° C. (e.g., about 350° C.). The powder compact may form a green body on the article. The powder compact may be made up of particles of any of the aforementioned ceramics, such as Y₃Al₅O₁₂ (YAG), Y₄Al₂O₉(YAM), Y₂O₃, Er₂O₃, Gd₂O₃, Gd₃Al₅O₁₂ (GAG), YF₃, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, or a ceramic compound composed of Y₄Al₂O₉ and at least one phase of Y₂O₃—ZrO₂.

In some embodiments, the article may be a suitable chamber component as described with respect to FIG. 1. For example, the article could be any of, but not limited to, a lid, a nozzle, an electrostatic chuck (e.g., ESC 150), a showerhead (e.g., showerhead 130), a liner (e.g., outer liner 116 or inner liner 118) or liner kit, or a ring (e.g., ring 146). The article may be a pre-sintered ceramic article, and may be composed of one or more of Al₂O₃, AlN, SiN, or SiC.

At block 506, the article and the powder compact may optionally be placed into a mold. In one embodiment, the mold is a graphite mold. In one embodiment, the inner surface of the mold that will interface with the powder compact is coated with a non-stick material prior to placing the article or powder compact in the mold. The non-stick material may be, for example, boron nitride (BN). In one embodiment, the powder compact is disposed over the article, and the article and powder compact are placed together into the mold. In another embodiment, the powder compact is placed into the mold, and the article is then inserted into the mold. Insertion of the article into the mold may cause the powder compact to be disposed on the surface of the article.

At block 510, the article and powder compact are placed into a furnace and a hot press process is performed to hot press the powder compact against the article. If a mold is used, then the mold containing the article and the powder compact may be placed into the furnace. To perform the hot press process, at block 512 the article and powder compact are heated to a temperature of 50-80% of a melting point for the powder compact (e.g., 50-80% of the temperature at which particles in the powder compact begin to melt). In other embodiments, temperatures up to 90% or 95% of the melting point of the powder compact may be used. The temperature used to perform the sintering may be, for example, on the order of 1200-1650° C. In one embodiment, a temperature of 1600° C. is used (e.g., for the Y—O—F ceramic). At block 514, a pressure is applied to compress the powder compact against the article. A pressure of about 15-100 Mega Pascals (MPa) may be applied. In one embodiment, a pressure of 15-60 MPa is applied. In another embodiment, a pressure of about 15-30 MPa is applied. In a further example a uniaxial pressure of about 35-40 MPa is applied (e.g., for the Y—O—F ceramic). In one embodiment, the pressure that is applied is a uniaxial pressure. For example, if a mold is used, then the mold may have an opening in which a punch applies uniaxial pressure that presses the powder compact against the mold and the article. The pressure and elevated temperature may be applied for the hot pressing process for a duration of about 1-6 hours in some embodiments. Alternatively, a longer or shorter duration may be used. The hot pressing may be performed under an Ar flow, under vacuum, under a N₂ flow, or under a flow of another inert gas. The flow of the inert gas may be, for example, around 1.5-2.5 L/min. At block 516 the powder compact is sintered into a sintered ceramic protective layer and bonded to the article as a result of the hot pressing. The bond between the sintered ceramic protective layer and the article may be a diffusion bond in embodiments that is caused by the heat and pressure of the hot pressing.

At block 520, it is determined whether any additional protective layers are to be formed. If so, the method returns to block 504 and another powder compact is disposed on the article over the sintered ceramic protective layer. This process may be repeated a number of times until a target number of sintered ceramic protective layers are formed. If no additional protective layers are to be formed, the method continues to block 525 or ends. At block 525, the sintered ceramic protective layer (or multiple sintered ceramic protective layers) may be cut by a laser cutter.

In some embodiments, a surface of the sintered ceramic protective layer is polished. For example, the surface may be polished to an average surface roughness (Ra) of about 5-20 micro-inches in an embodiment. In a further embodiment, the sintered ceramic protective layer is polished to an average surface roughness (Ra) of about 8-12 micro-inches. Prior to polishing the sintered ceramic protective layer may have an average surface roughness of about 80-120 micro-inches in embodiments.

In some embodiments, the article may have a first coefficient of thermal expansion (CTE), a first sintered ceramic protective layer may have a second CTE, and a second sintered ceramic protective layer may have a third CTE, where the second CTE has a value that is between the first CTE and the third CTE. For example, if the article is a metal article, such as aluminum or an aluminum alloy, then the first sintered ceramic protective layer may alleviate stress to the second sintered ceramic protective layer caused during heating and cooling.

FIG. 6 is a flow diagram illustrating a method 600 for forming multi-layer sintered ceramic by hot pressing two pre-sintered ceramic articles together, according to an embodiment. At block 604, a first ceramic article is provided and a ceramic welding compound may be applied onto a surface of the first ceramic article. The ceramic welding compound may be a powder compact in the format of foil or tape that includes ceramic particles of a ceramic having a low melting temperature (e.g., of about 100-200° C.). Examples of ceramics that may be used for the ceramic welding compound include silica based and high alumina based ceramic welding materials such as a high purity fused silica based ceramic welding material, a crystalline silica based ceramic welding material, fire clay based ceramic welding material, and so on. For one example, a ceramic welding material may include SiO₂ at a concentration of 90 mol %, Al₃O₃ at a concentration of 6.0 mol %, and Fe₂O₃ at a concentration of 1.5 mol %. The first ceramic article may be a relatively inexpensive sintered ceramic with high mechanical strength, such as Al₂O₃, AlN, SiN, SiC, and so on. In some embodiments, the first sintered ceramic article may be a suitable chamber component as described with respect to FIG. 1.

At block 606, a second sintered ceramic article is disposed on the first sintered ceramic article. A surface of the second sintered ceramic article may conform to a surface of the first sintered ceramic article. In some embodiments, the surfaces of the two sintered ceramic articles are non-planar surfaces. In some embodiments the ceramic welding compound may be sandwiched between the first and second sintered ceramic articles. The second sintered ceramic article may be any of the aforementioned ceramics discussed with regards to the sintered ceramic protective layer, such as Y₃Al₅O₁₂ (YAG), Y₄Al₂O₉ (YAM), Y₂O₃, Er₂O₃, Gd₂O₃, Gd₃Al₅O₁₂ (GAG), YF₃, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, or a ceramic compound composed of Y₄Al₂O₉ and at least one phase of Y₂O₃—ZrO₂.

At block 610, the first and second sintered ceramic articles are placed into a furnace and a hot press process is performed to hot press the second sintered ceramic article against the first sintered ceramic article. To perform the hot press process, at block 612 the sintered ceramic articles may be heated to a temperature of 50-80% of a melting point for the first and second sintered ceramic articles. In other embodiments, temperatures up to 90% or 95% of the melting point of the sintered ceramic articles may be used. The temperature used to perform the sintering may be, for example, on the order of 1200-1500° C. Alternatively, a lower temperature may be used that is above the melting point of the particles in the ceramic welding compound (e.g., around 200-500° C.).

At block 614, a pressure is applied to compress the second sintered ceramic article against the first sintered ceramic article. A pressure of about 15-100 Mega Pascals (MPa) may be applied. In one embodiment, a pressure of 15-30 MPa is applied. In one embodiment, the pressure that is applied is a uniaxial pressure. At block 616 the second sintered ceramic article is diffusion bonded to the first sintered ceramic article.

At block 625, the second sintered ceramic article may be cut by a laser cutter to a target shape.

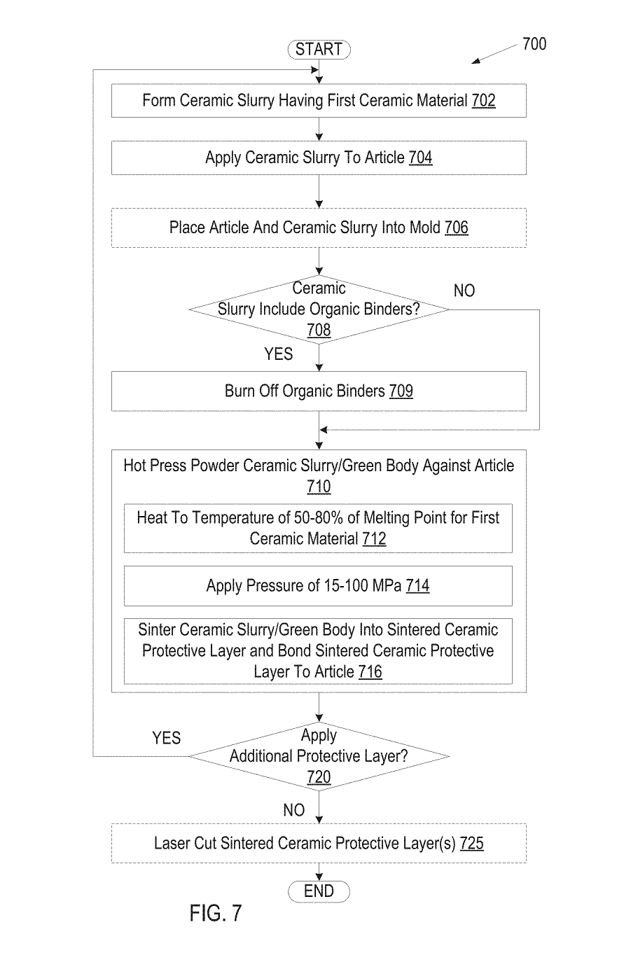

FIG. 7 is a flow diagram illustrating a method 700 for forming a sintered ceramic protective layer onto an article from a ceramic slurry, according to an embodiment. The ceramic slurry may or may not be a sol-gel compound. At block 702 of method 700 a ceramic slurry having a first ceramic material composition is formed. The first ceramic material composition may contain ceramic particles as described above with regards to the sintered ceramic protective layer. For example, the particles may be any of Y₃Al₅O₁₂ (YAG), Y₄Al₂O₉ (YAM), Y₂O₃, Er₂O₃, Gd₂O₃, Gd₃Al₅O₁₂ (GAG), YF₃, Nd₂O₃, Er₄Al₂O₉, Er₃Al₅O₁₂ (EAG), ErAlO₃, Gd₄Al₂O₉, GdAlO₃, Nd₃Al₅O₁₂, Nd₄Al₂O₉, NdAlO₃, YₓO_{y}F_{z}, a solid solution or multiphase compound of Y₂O₃—ZrO₂, or a ceramic compound composed of Y₄Al₂O₉ and at least one phase of Y₂O₃—ZrO₂.

At block 704, the ceramic slurry is applied to an article. The ceramic slurry may contain a mixture of a powdered ceramic having an average particle diameter of about 0.01-1 μm in embodiments. The ceramic slurry may additionally contain a dispersing medium (e.g., a solvent) and/or a binder. The dispersing medium may be, for example, water, aromatic compounds such as toluene and xylene, alcohol compounds such as ethyl alcohol, isopropyl alcohol and butyl alcohol, or a combination thereof. The binder may be an organic binder and may include polyvinyl butyral resins, cellulose resins, acrylic resins, vinyl acetate resins, polyvinyl alcohol resins, and so on. The ceramic slurry may additionally include a plasticizer such as polyethylene glycol and/or phthalic esters.

The ceramic slurry may form a green body on the article. The ceramic slurry may be formed on the article via any standard application technique, such as spraying, dip coating, injection molding, painting, doctor blade coating, and so on. In some embodiments, the article may be a suitable chamber component as described with respect to FIG. 1. For example, the article could be any of, but not limited to, a lid, a nozzle, an electrostatic chuck (e.g., ESC 150), a showerhead (e.g., showerhead 130), a liner (e.g., outer liner 116 or inner liner 118) or liner kit, or a ring (e.g., ring 146). The article may be a pre-sintered ceramic article, and may be composed of one or more of Al₂O₃, AlN, SiN, or SiC.

At block 706, the article and the ceramic slurry may optionally be placed into a mold. In one embodiment, the mold is a graphite mold. In one embodiment, the inner surface of the mold that will interface with the ceramic slurry is coated with a non-stick material prior to placing the article or powder compact in the mold. The non-stick material may be, for example, boron nitride (BN), and may prevent the ceramic slurry from binding to the mold. In one embodiment, the ceramic slurry is disposed over the article, and the article and ceramic slurry are placed together into the mold. In another embodiment, the ceramic slurry is placed into the mold, and the article is then inserted into the mold. Insertion of the article into the mold may cause the ceramic slurry to be disposed on the surface of the article. In another embodiment, the article is placed in the mold and the ceramic slurry is then injected into a space between the article and the walls of the mold.

At block 708, a determination may be made as to whether the ceramic slurry includes an organic binder. If the ceramic slurry includes an organic binder, then the method proceeds to block 709. Otherwise the method continues to block 710.

At block 709, the article and ceramic slurry (a green body at this point) are placed into a first furnace and heat is applied to burn off the organic binders from the ceramic slurry. The applied heat may have a temperature of about 100-200° C. (e.g., about 110-130° C. in some embodiments). The heat may be applied while the furnace is under vacuum, or while an inert gas such as Ar or N. The heat may be applied for a duration of about 2-5 hours to burn off the organic binders. If a mold was used, then the entire assembly including the mold, the article and the ceramic slurry may be placed in the furnace. The ceramic slurry may also be dried by the heat. The ceramic slurry will be referred to from this point as a green body since technically it is no longer a slurry once it has dried.

At block 710, the article and green body are placed into a second furnace and a hot press process is performed to hot press the ceramic slurry against the article. Different furnaces may be used for the hot pressing and to burn off organic material to avoid contaminating the furnace that performs the hot pressing. If a mold is used, then the mold containing the article and the green body may be placed into the furnace. To perform the hot press process, at block 712 the article and green body are heated to a temperature of 50-80% of a melting point for the particles in the ceramic slurry. In other embodiments, temperatures up to 90% or 95% of the melting point of the particles may be used. The temperature used to perform the sintering may be, for example, on the order of 1200-1650° C. In one embodiment, a temperature of 1600° C. is used (e.g., for the Y—O—F ceramic).

At block 714, a pressure is applied to compress the green body against the article. A pressure of about 15-100 Mega Pascals (MPa) may be applied. In one embodiment, a pressure of 15-30 MPa is applied. In a further example a uniaxial pressure of about 35-40 MPa is applied (e.g., for the Y—O—F ceramic). In one embodiment, the pressure that is applied is a uniaxial pressure. For example, if a mold is used, then the mold may have an opening in which a punch applies uniaxial pressure that presses the green body against the mold and the article. The pressure and elevated temperature may be applied for the hot pressing process for a duration of about 1-6 hours in some embodiments. Alternatively, a longer or shorter duration may be used. The hot pressing may be performed under an Ar flow, under vacuum, under a N₂ flow, or under a flow of another inert gas. The flow of the inert gas may be, for example, around 1.5-2.5 L/min.

At block 716 the green body is sintered into a sintered ceramic protective layer and bonded to the article as a result of the hot pressing. The bond between the sintered ceramic protective layer and the article may be a diffusion bond in embodiments that is caused by the heat and pressure of the hot pressing.

At block 720, it is determined whether any additional protective layers are to be formed. If so, the method returns to block 704 and another ceramic slurry is disposed on the article over the sintered ceramic protective layer. This process may be repeated a number of times until a target number of sintered ceramic protective layers are formed. If no additional protective layers are to be formed, the method continues to block 725 or ends. At block 725, the sintered ceramic protective layer (or multiple sintered ceramic protective layers) may be cut by a laser cutter.

In some embodiments, a surface of the sintered ceramic protective layer is polished. For example, the surface may be polished to an average surface roughness (Ra) of about 5-20 micro-inches in an embodiment. In a further embodiment, the sintered ceramic protective layer is polished to an average surface roughness (Ra) of about 8-12 micro-inches. Prior to polishing the sintered ceramic protective layer may have an average surface roughness of about 80-120 micro-inches in embodiments.

In some embodiments, the article may have a first coefficient of thermal expansion (CTE), a first sintered ceramic protective layer may have a second CTE, and a second sintered ceramic protective layer may have a third CTE, where the second CTE has a value that is between the first CTE and the third CTE. For example, if the article is a metal article, such as aluminum or an aluminum alloy, then the first sintered ceramic protective layer may alleviate stress to the second sintered ceramic protective layer caused during heating and cooling.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular embodiments may vary from these exemplary details and still be contemplated to be within the scope of the present disclosure.

Reference throughout this specification to “one embodiment” or “an embodiment” indicates that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
disposing a powder compact on a surface of an article, wherein the article is a chamber component of a processing chamber;
hot pressing the powder compact against the surface of the article, the hot pressing comprising:
heating the article and the powder compact to a temperature that is 50-80% of a melting point of the powder compact; and
applying a pressure of 15-100 Megapascals;
wherein the hot pressing sinters the powder compact into a sintered ceramic protective layer and bonds the sintered ceramic protective layer to the surface of the article.

2. The method of claim 1, wherein the article comprises a ceramic selected from a group consisting of Al₂O₃, AlN, Si₃N₄ and SiC.

3. The method of claim 1, wherein the article comprises a metal selected from a group consisting of aluminum and an aluminum alloy.

4. The method of claim 1, wherein the powder compact consists essentially of particles selected from a group consisting of yttrium oxide, yttrium fluoride and yttrium oxy-fluoride.

5. The method of claim 1, wherein the powder compact consists essentially of a mixture of yttrium oxide and zirconium oxide.

6. The method of claim 1, wherein the powder compact consists essentially of a ceramic compound consisting of Y₄Al₂O₉ and an at least one phase composed of Y₂O₃—ZrO₂.

7. The method of claim 1, wherein the surface of the article is a non-planar surface, the method further comprising:
placing the article and the powder compact in a mold, wherein applying the pressure comprises applying uniaxial pressure using a punch.

8. The method of claim 1, further comprising:
laser cutting the sintered ceramic protective layer to achieve a predefined shape.

9. The method of claim 1, further comprising:
disposing an additional powder compact over the sintered ceramic protective layer; and
hot pressing the additional powder compact against the sintered ceramic protective layer, wherein the hot pressing of the additional powder compact against the sintered ceramic protective layer sinters the additional powder compact into a second sintered ceramic protective layer and bonds the second sintered ceramic protective layer to the sintered ceramic protective layer.

10. A method comprising:
applying a ceramic slurry of a first ceramic onto a surface of an article, wherein the article is a chamber component of a processing chamber;
hot pressing the ceramic slurry or a green body formed from the ceramic slurry against the surface of the article, the hot pressing comprising:
heating the article and the ceramic slurry or the green body to a temperature that is 50-80% of a melting point of the first ceramic; and
applying a pressure of 15-100 Megapascals;
wherein the hot pressing sinters the ceramic slurry or the green body into a sintered ceramic protective layer and bonds the sintered ceramic protective layer to the surface of the article.

11. The method of claim 10, wherein the article comprises a pre-sintered ceramic selected from a group consisting of Al₂O₃, AlN, Si₃N₄ and SiC.

12. The method of claim 10, wherein the article comprises a metal selected from a group consisting of aluminum and an aluminum alloy.

13. The method of claim 10, wherein the first ceramic is selected from a group consisting of yttrium oxide, yttrium fluoride and yttrium oxy-fluoride.

14. The method of claim 10, wherein the first ceramic is selected from a group consisting of a) yttrium oxide and zirconium oxide and b) a ceramic compound consisting of Y₄Al₂O₉ and an at least one phase composed of Y₂O₃—ZrO₂.

15. The method of claim 10, wherein applying the ceramic slurry onto the surface of the article is performed using one of a dip coating process, a doctor blade process, a spraying process, or a painting process.

16. The method of claim 10, wherein the ceramic slurry comprises an organic binder, the method further comprising:
prior to performing the hot pressing, loading the article and the ceramic slurry into a first furnace and heating the article and the ceramic slurry to a first temperature of about 100-200° C. to burn off the organic binder and dry the ceramic slurry to form the green body from the ceramic slurry; and
subsequently loading the article and the green body into a second furnace, wherein the hot pressing is performed in the second furnace.

17. The method of claim 10, wherein the surface of the article is a non-planar surface, the method further comprising:
placing the article and the ceramic slurry or the green body in a mold, wherein applying the pressure comprises applying uniaxial pressure using a punch.

18. The method of claim 10, further comprising:
laser cutting the sintered ceramic protective layer to achieve a predefined shape.

19. The method of claim 10, further comprising:
applying an additional ceramic slurry onto the sintered ceramic protective layer; and
hot pressing the additional ceramic slurry or an additional green body formed from the second ceramic slurry against the sintered ceramic protective layer, wherein the hot pressing of the ceramic slurry or the additional green body against the sintered ceramic protective layer sinters the additional ceramic slurry or the additional green body into a second sintered ceramic protective layer and bonds the second sintered ceramic protective layer to the sintered ceramic protective layer.

20. A method comprising:
applying a ceramic welding compound comprising a first ceramic onto a surface of a first sintered ceramic article, wherein the first sintered ceramic article is selected from a group consisting of Al₂O₃, AlN, Si₃N₄ and SiC, and wherein the first sintered ceramic article is a chamber component of a processing chamber;
disposing a second sintered ceramic article onto the ceramic welding compound, wherein the second sintered ceramic article is selected from a group consisting of yttrium fluoride, yttrium oxy-fluoride, and a mixture of yttrium oxide and zirconium oxide; and
hot pressing the second sintered ceramic article against the first sintered ceramic article, the hot pressing comprising:
heating the first sintered ceramic article and the second sintered ceramic article to a temperature that is 50-80% of a melting point of the first sintered ceramic article and
the second sintered ceramic article; and
applying a pressure of 15-100 Megapascals;
wherein the hot pressing bonds the second sintered ceramic article to the first sintered ceramic article.
